(19) United States
(12) Patent Application Publication
(10) Pub. No.: US 2026/0346177 A1
(43) Pub. Date: Nov. 5, 2026

(54) AIR TREATMENT DEVICE

(71) Applicant: COWAY Co., Ltd., Gongju-si (KR)

(72) Inventors: Jhe Hong KIM, Seoul (KR); Jin Min KIM, Seoul (KR); Ki Soo KIM, Seoul (KR); Dong Hun LEE, Seoul (KR); Do Yeop KIM, Seoul (KR); Kyu Wan SONG, Seoul (KR)

(73) Assignee: COWAY Co., Ltd., Gongju-si (KR)

(21) Appl. No.: 19/705,907

(22) Filed: Jun. 12, 2026

Related U.S. Application Data
(63) Continuation of application No. PCT/KR2024/010572, filed on Jul. 22, 2024.

(30) Foreign Application Priority Data
Dec. 20, 2023 (KR) 10-2023-0187449

(51) Int. Cl. B01D 46/00; B01D 46/24

(52) U.S. Cl. CPC B01D 46/0049; B01D 46/24; B01D 2273/30

(57) ABSTRACT

There may be provided an air treatment device including: a body having an inlet through which air is introduced and an outlet through which the air is discharged to an outside; a guide vane guiding the filtered air to be discharged in one direction, and having a plurality of protrusions formed on an upper portion thereof; a blowing fan accommodated inside the body, and configured to rotate about a predetermined center of rotation to provide a blowing force for introducing the air into the interior of the body and discharging the air to the outside; a duct having a discharge flow path formed therein; and a filter filtering the air introduced into the interior of the body.

### TECHNICAL FIELD

The present disclosure relates to an air treatment device.

### BACKGROUND ART

In general, an air treatment device is a device purifying polluted air and changing the polluted air into fresh air, and the air treatment device performs a function of eliminating dust and bacteria and removing odors by passing introduced air through an air purification filter. On the other hand, if vortices are unintentionally generated inside the air treatment device such that introduced air cannot efficiently reach the filter or filtered air cannot be efficiently discharged through the outlet, there is a problem in that flow efficiency is reduced. Furthermore, when flow separation occurs inside the air treatment device, there is a problem in that a loss of an air flow occurs.

In this regard, Korean Patent Application Publication No. 10-2023-0094049 Published on Jun. 27, 2023 “Air Purifier” Patent Document 1 of Samsung Electronics Co., Ltd. discloses a vortex reduction chamber formed inside a bypass flow path of an air purifier to reduce a vortex in air flowing through the bypass flow path. The vortex reduction chamber of Patent Document 1 may be concavely formed on an inner surface of a filter mounting frame. The vortex reduction chamber may be formed in a shape reducing a vortex in an air flow passing through the bypass flow path.

However, Patent Document 1 is problematic in that the chamber merely prevents the formation of a vortex of some air passing through the bypass flow path, without recognizing the improvement of the flow efficiency of the overall air flowing in the air purifier. Furthermore, Patent Document 1 has a limitation in lacking recognition of increasing the flow efficiency by generating a vortex as needed, because merely the elimination of the vortex in the flow path by the chamber is disclosed. In other words, furthermore, embodiments of the vortex prevention chamber of Patent Document 1 may convert the vortex passing through the bypass flow path into a laminar flow, but have a problem of being unable to improve flow efficiency in parts other than the bypass flow path, such as a blowing fan and a duct.

Furthermore, Korean Patent Publication No. 2021-0136399 of Chungho Nais Co., Ltd., entitled “Blower and Air Purifier Including the Same” (Patent Document 2), discloses blades having effective thicknesses and curvatures derived by simulating, through flow analysis, air flow around a blowing fan and guide vanes of an air purifier.

However, unlike descriptions in the specification thereof, Patent Document 2 has a problem of an inefficient flow of air discharged from the guide vane because a vortex or turbulence occurs at an end of the guide vane. Furthermore, in Patent Document 2, merely the thickness and curvature of the guide vane are disclosed, and lacking a disclosure on changing the shape of the guide vane itself, there is a limitation in improving a vortex or turbulence. Furthermore, Patent Document 2 has a problem of being unable to improve flow efficiency in parts other than the guide vane, such as a blowing fan and a duct, as components other than the guide vane.

### PRIOR ART DOCUMENTS

### Patent Document

(Patent Document 1) Korean Patent Application Publication No. 10-2023-0094049 Published on Jun. 27, 2023

(Patent Document 2) Korean Patent Application Publication No. 10-2021-0136399 Published on Nov. 25, 2021

### DETAILED DESCRIPTION OF INVENTION

### Technical Problems

Embodiments of the present disclosure provide an air treatment device with improved energy efficiency by improving the flow efficiency of air inside the air treatment device through various structures.

### Technical Solution

An air treatment device according to an aspect of the present disclosure includes: a body having an inlet through which air is introduced and an outlet through which the air is discharged to an outside; a guide vane guiding the filtered air to be discharged in one direction, and having a plurality of protrusions formed on an upper portion thereof; a blowing fan accommodated inside the body, and configured to rotate about a predetermined center of rotation to provide a blowing force for introducing the air into the interior of the body and discharging the air to the outside; a duct having a discharge flow path formed therein; and a filter filtering the air introduced into the interior of the body, wherein the plurality of protrusions are disposed at an upper side of the blowing fan to convert a flow of the air rising from one surface of the guide vane and the air rising from the other surface of the guide vane into a laminar flow.

Further, the blowing fan may include: a plurality of blades having at least a portion extending in a direction parallel to the predetermined center of rotation; a motor providing a driving force for rotating the plurality of blades; and a blade support connected to the plurality of blades, and extending in a direction offset from the predetermined center of rotation between the motor and the plurality of blades, wherein a support protrusion configured to generate a vortex is formed on the blade support.

Further, the support protrusion may be disposed between the plurality of blades on a support surface of the blade support, a curvature of one surface of the support protrusion may be greater than a curvature of the other surface opposite to the one surface of the support protrusion, and a vertical height of the support protrusion and a width of the support protrusion on the support surface may be smaller than a horizontal thickness of each of the plurality of blades.

Further, the vertical height and the width of the support protrusion may be 0.01 times or more and 0.3 times or less a height and a horizontal width of each of the plurality of blades.

Further, a plurality of dimples having a groove shape may be formed in the duct, and the plurality of dimples may generate a vortex in the discharged air to reduce air resistance and accelerate air flow.

Further, a diameter of one of the plurality of dimples disposed at a lower side may be larger than a diameter of another of the plurality of dimples disposed at an upper side.

Further, the discharged air may flow along an inclined portion of the duct and may be accelerated by the plurality of dimples, while being uniformly distributed along an upper surface of each of the plurality of blades without being separated due to the support protrusion.

Further, a blade protrusion forming a vortex may be formed on each of the plurality of blades.

### Effect of Invention

Embodiments of the present disclosure have an effect of maximizing flow efficiency by forming protrusions on guide vanes to prevent disturbance of air flow and convert vortices into laminar flow.

Furthermore, a blade protrusion prevents a loss of air by generating a vortex to delay flow separation.

Furthermore, a dimple formed in a duct prevents a loss of air by generating a vortex of air to delay flow separation.

Furthermore, gradually forming sizes of the dimple to be different maximizes a delay of flow separation.

### BRIEF DESCRIPTION OF THE DRAWINGS

FIG. 1 is a perspective view of an air treatment device.

FIG. 2 is an exploded perspective view of FIG. 1.

FIG. 3 is a cross-sectional view taken along line I-I of FIG. 1.

FIG. 4 is an enlarged view of A of FIG. 2.

FIG. 5 is an enlarged view of B of FIG. 2.

FIG. 6 is a plan view of FIG. 5.

FIG. 7 is a cross-sectional view taken along line II-II of FIG. 5.

FIG. 8 is an enlarged view of C of FIG. 2.

FIG. 9 is a cross-sectional view taken along line III-III of FIG. 8.

FIG. 10 is an enlarged view of D of FIG. 9.

### DETAILED DESCRIPTION OF THE INVENTION

Hereinafter, specific embodiments for implementing a spirit of the present disclosure will be described in detail with reference to the drawings.

In describing the present disclosure, detailed descriptions of known configurations or functions may be omitted to clarify the present disclosure.

When an element is referred to as being ‘connected’ to, or ‘supported’ by another element, it should be understood that the element may be directly connected to, or supported by another element, but that other elements may exist in the middle.

The terms used in the present disclosure are only used for describing specific embodiments, and are not intended to limit the present disclosure. Singular expressions include plural expressions unless the context clearly indicates otherwise.

Further, in the present disclosure, it is to be noted that expressions, such as the upper side, the lower side, and the side surface, are described based on the illustration of drawings, but may be modified if directions of corresponding objects are changed. For the same reasons, some components are exaggerated, omitted, or schematically illustrated in the accompanying drawings, and the size of each component does not fully reflect the actual size.

Further, terms including ordinal numbers, such as first and second, may be used for describing various elements, but the corresponding elements are not limited by these terms. These terms are only used for the purpose of distinguishing one element from another element.

In the present specification, it is to be understood that the terms such as “including” are intended to indicate the existence of the certain features, areas, integers, steps, actions, elements, combinations, and/or groups thereof disclosed in the specification, and are not intended to preclude the possibility that one or more other certain features, areas, integers, steps, actions, elements, combinations, and/or groups thereof may exist or may be added.

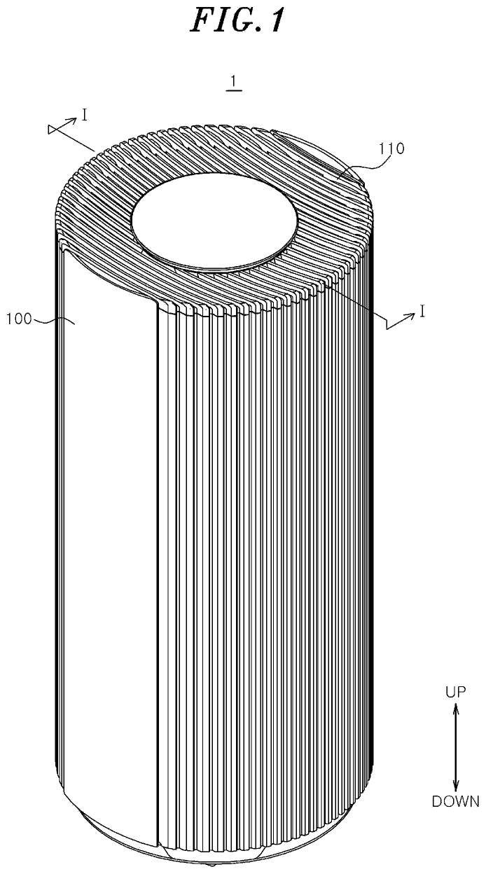

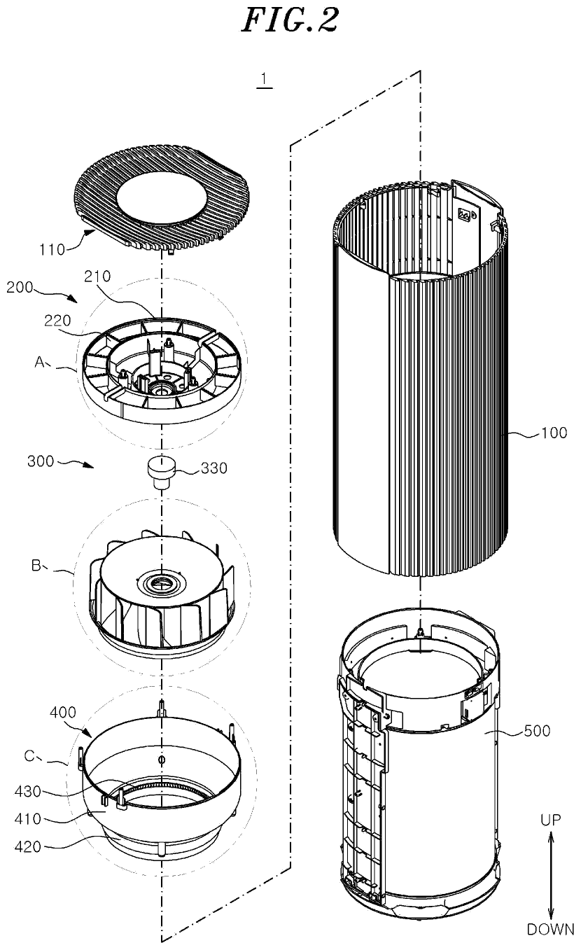

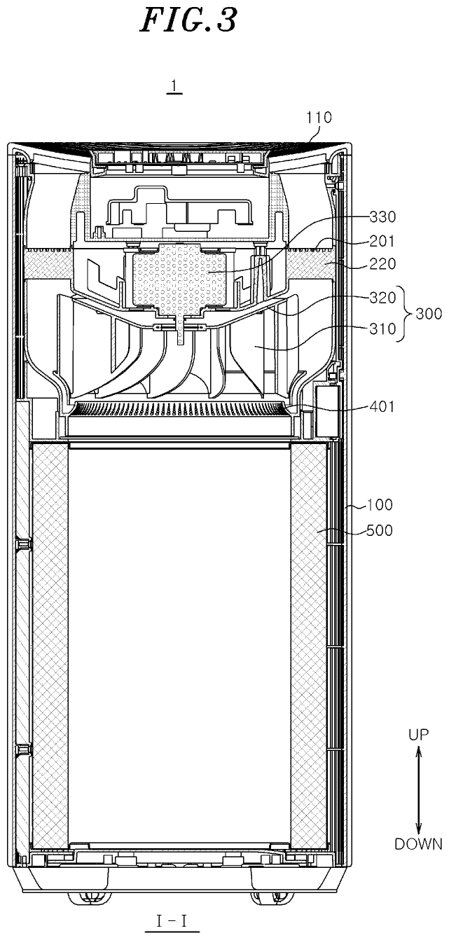

Hereinafter, an air treatment device 1 according to an embodiment of the present disclosure will be described with reference to FIGS. 1 to 3. The air treatment device 1 may purify polluted air into clean air by filtering dust, odor particles, and the like of the air introduced into the air treatment device 1. Furthermore, the air treatment device 1 may suck air outside the air treatment device 1 to the inside, and may discharge the clean air purified inside to the outside. The air treatment device 1 may include a body 100, a guide vane 200, a blowing fan 300, a duct 400, and a filter 500.

The body 100 may accommodate one or more of the guide vane 200, a blowing fan 300, the duct 400, and the filter 500 therein. An inlet through which air is introduced and an outlet 110 through which air is discharged to the outside may be formed in the body 100. The body 100 may be formed in a cylindrical shape. Outside air may be introduced into the interior of the body 100 through an inlet by the body 100, and after being filtered by the filter 500, the outside air may be discharged to the outside through an outlet.

The outlet 110 may discharge the air filtered inside the air treatment device 1 to the outside. The outlet 110 may be formed on an upper surface of the body 100. For example, the outlet 110 may be opened upwardly, and may be provided in plurality. However, the idea of the present disclosure is not limited thereto, and the outlet 110 may be formed on a front surface or a rear surface of the body 100.

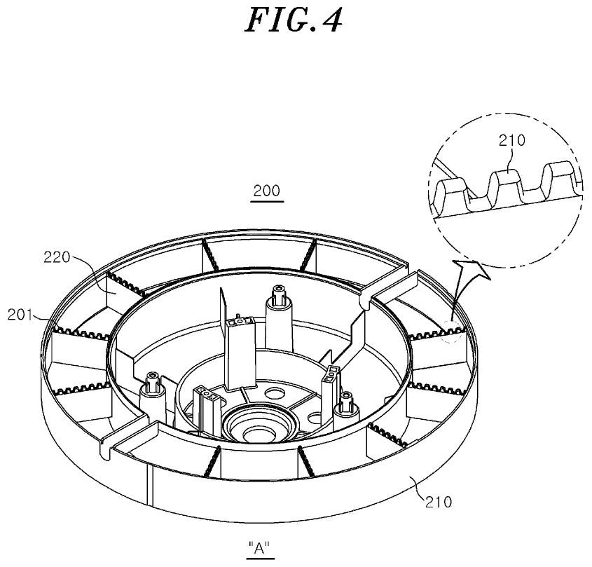

Referring to FIG. 4, the guide vane 200 may guide the filtered air to be discharged in one direction. Filtered air may be discharged upward from one or more of the front surface and the rear surface of the body 100 by the guide vane 200. A plurality of protrusions 201 may be formed on the guide vane 200. The guide vane 200 may include a guide vane body part 210 and a guide part 220.

The guide vane body part 210 may support the guide part 220. The guide vane body part 210 may be disposed between the outlet 110 and the blowing fan 300. A horizontal width of the guide vane body part 210 may be smaller than a horizontal width of the body 100. The guide vane body part 210 may be formed in an annular shape, and a vertical height of the guide vane body part 210 may be smaller than a height H of a blade to be described later.

A plurality of guide parts 220 may be provided, and the plurality of guide parts 220 may be spaced apart from each other in a horizontal direction, and the filtered air may be discharged to the outside of the body 100 through spaces between the plurality of guide parts 220. The plurality of protrusions 201 may be formed on an upper portion of the guide part 220.

The plurality of protrusions 201 may convert the flow of air, preventing turbulence from forming immediately downstream (e.g., directly above) of the guide vane 200. The plurality of protrusions 201 may be formed on an upper portion of the guide vane 200. The plurality of protrusions 201 may convert a flow of air rising from one surface of the guide part 220 and air rising from the other surface of the guide part 220 into a laminar flow. The plurality of protrusions 201 may convert the flow of air, allowing air rising from one surface of the guide part 220 and air rising from the other surface of the guide part 220 to merge at a position spaced apart toward a downstream side from the guide vane 200, without colliding immediately downstream of the guide vane 200. The plurality of protrusions 201 may be disposed at an upper side of the blowing fan 300. The plurality of protrusions 201 may be spaced apart in the horizontal direction. A horizontal width of the plurality of protrusions 201 may be greater than 1/10 and smaller than ⅕ of a horizontal width of the guide part 220. The plurality of protrusions 201 may have a trapezoidal shape having an upper width smaller than a lower width. A height of the plurality of protrusions 201 may be smaller than or equal to the lower width of the plurality of protrusions 201.

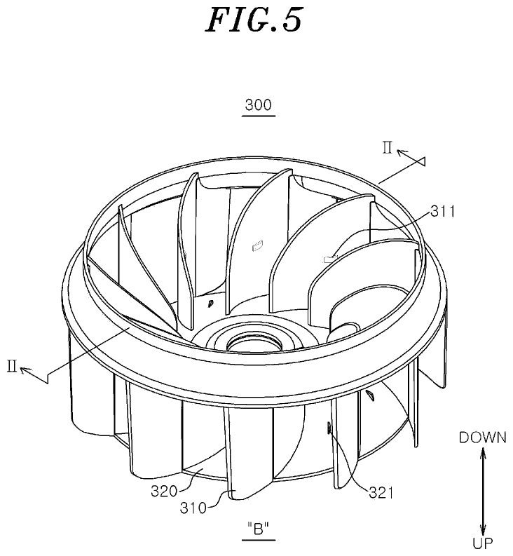

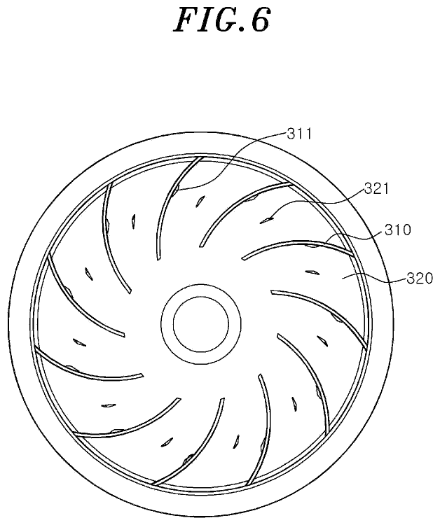

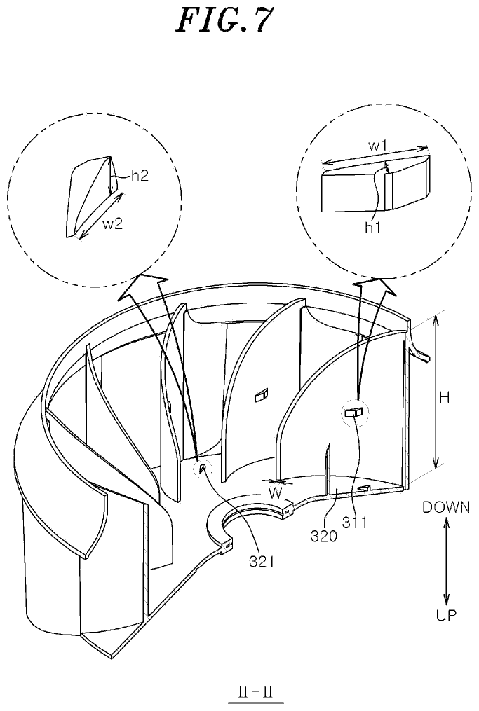

Referring to FIGS. 5 to 7, the blowing fan 300 may provide a blowing force, passing outside air through the filter 500. The blowing fan 300 may be accommodated inside the body 100. The blowing fan 300 may be configured to rotate about a predetermined center of rotation so as to provide a blowing force for introducing air into the body 100 and discharging the air to the outside. The blowing fan 300 may include a blade 310, a blade support 320, and a motor 330.

The blade 310 may be supported by the blade support 320 and rotatably driven. Such a blade 310 may provide a blowing force for flowing the outside air into the body 100 and discharging the filtered air to the outside. At least a portion of the blade 310 may extend in a direction parallel to the predetermined center of rotation of the blowing fan 300. A plurality of blades 310 may be provided. A blade protrusion 311 may be formed on each of the plurality of blades 310.

The blade protrusion 311 may form a vortex. The blade protrusion 311 may be disposed on each of the plurality of blades 310. The blade protrusion 311 may be formed on an inner curved surface of each of the plurality of blades 310. A curvature of one surface of the blade protrusion 311 may be greater than a curvature of the other surface opposite to the one surface of the blade protrusion 311. A vertical height h1 and a width w1 on a support surface of the blade protrusion 311 may be smaller than a horizontal width W of each of the plurality of blades 310. The vertical height h1 and the width w1 of the blade protrusion 311 may be 0.01 times or more and 0.3 times or less a height H and the horizontal width W of each of the plurality of blades 310. For example, the vertical height h1 and the width w1 of the blade protrusion 311 may be 0.1 times the height H and the horizontal width W of each of the plurality of blades 310.

The blade support 320 may support the blade 310. The blade support 320 may be connected to the plurality of blades 310. The blade support 320 may extend between the motor 330 and the plurality of blades 310 in an off-axis direction relative to the predetermined center of rotation. For example, the blade support 320 may extend in the horizontal direction. A support protrusion 321 may be formed on the blade support 320.

The support protrusion 321 may form a vortex. The support protrusion 321 may be disposed between the plurality of blades 310 on a support surface of the blade support 320. The support protrusion 321 may be disposed to overlap a central portion of an imaginary line extending from a radially inner end of one blade 310 to a radially outer end of another adjacent blade 310. A curvature of one surface of the support protrusion 321 may be greater than a curvature of the other surface opposite to the one surface of the support protrusion 321. A vertical height h2 and a width w2 on the support surface of the support protrusion 321 may be smaller than the horizontal width W of the blade 310. The vertical height h2 and the width w2 of the support protrusion 321 may be 0.01 times or more and 0.3 times or less the height H and the horizontal width W of the blade 310. For example, the vertical height h2 and the width w2 of the support protrusion 321 may be 0.1 times the height H and the horizontal width W of the blade 310.

The motor 330 may provide a driving force for rotating the plurality of blades 310. The motor 330 may be driven to rotate the plurality of blades 310 in one direction or to rotate the plurality of blades 310 in the other direction opposite to the one direction. Furthermore, the motor 330 may be configured to rotate about a rotation shaft extending in a first direction.

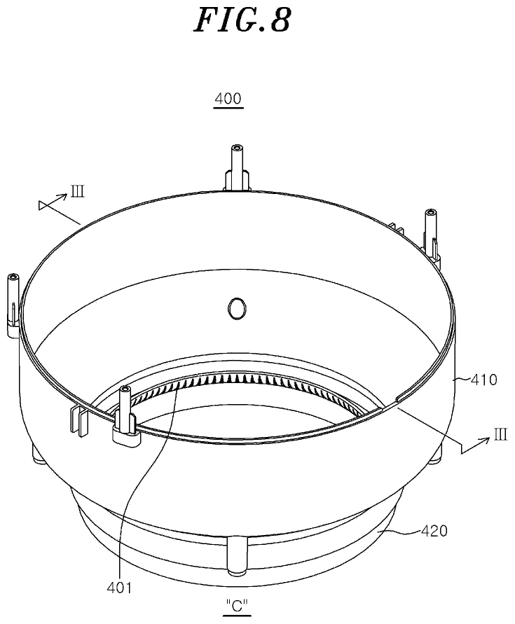

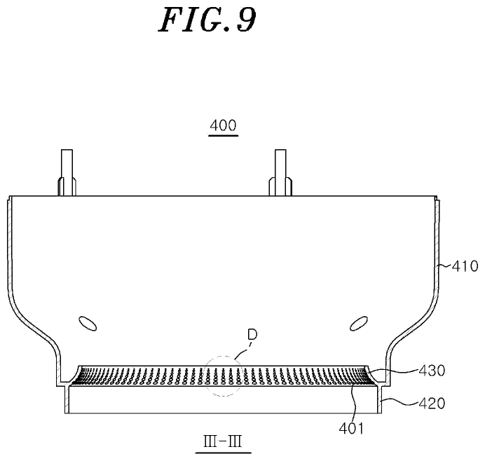

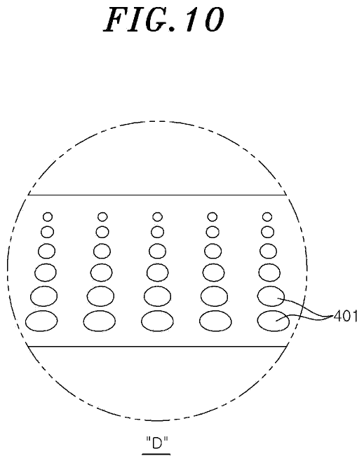

Referring to FIGS. 8 to 10, the duct 400 may prevent leakage of flowing air. The duct 400 may have a discharge flow path formed therein. The duct 400 may be formed to be inclined or curved in a flow direction of the rotatingly flowing air. The duct 400 may be disposed at a lower side of the blowing fan 300. A dimple 401 may be formed in the duct 400. The duct 400 may include a duct discharge part 410, a duct inlet part 420, and a taper guide 430.

The duct discharge part 410 may be formed at an upper side of the duct inlet part 420, and the duct inlet part 420 may be formed at a lower side of the duct discharge part 410. The air filtered by the filter 500 may pass through the duct inlet part 420, flow to the duct discharge part 410, and be discharged to the outlet 110. The taper guide 430 may be disposed at an upper side of the duct inlet part 420, has a tapered shape having a width becoming narrower toward an upper side, and may guide air into the duct 400.

The dimple 401 may have a groove shape. A plurality of dimples 401 may be provided. The plurality of dimples 401 may generate a vortex in the discharged air to reduce air resistance and accelerate the air flow. A diameter of at least one of the plurality of dimples 401 disposed at a lower side may be larger than a diameter of another of the plurality of dimples 401 disposed at an upper side. The dimple 401 may be formed on an inner surface of the taper guide 430.

The filter 500 may filter the air introduced into the interior of the body 100. The filter 500 may filter the air introduced from outside the air treatment device 1 into clean air. For example, the filter 500 may be an activated carbon deodorization filter (carbon filter) or a HEPA filter. The filter 500 may be disposed at a lower side of the duct 400.

Hereinafter, operations and effects of the air treatment device 1 having the above-described configuration will be described.

The air treatment device 1 of the present disclosure may increase energy efficiency by increasing the flow efficiency of air. The air treatment device 1 may form a vortex in a desired portion, and may suppress the formation of a vortex in a portion interfering with the efficient flow of air. The guide vane 200 may maximize flow efficiency by converting the flow of air from a vortex into a laminar flow. The flow of air may be more efficient by being converted into a laminar flow in the guide vane 200 before the discharged air exits to the outlet 110. Furthermore, the guide vane 200 may prevent disturbance of an air flow. When a vortex occurs on an upper portion of the guide vane 200, a disturbance may occur in the air flow, making it difficult for the air to be smoothly discharged through the outlet 110. However, this may be prevented by causing the airflow to undergo a transition to laminar flow at the guide vane 200.

The blowing fan 300 having the protrusion formed thereon may generate a vortex to delay flow separation, thereby preventing the loss of the air flow. When flow separation, as a phenomenon of a fluid such as air separating from a surface of an object, occurs, a loss of air may occur to decrease the efficiency of the air treatment device 1. Accordingly, the performance of the air treatment device 1 may be made efficient by generating a vortex to reduce flow separation.

The duct 400 having the dimple 401 formed therein may also generate a vortex to delay flow separation, thereby preventing the loss of the air flow. The dimples 401 formed in the duct 400 are formed to have different sizes according to the vertical height, and thus may generate a vortex more efficiently.

The air discharged after being filtered by the filter 500 may flow along an inclined portion of the duct 400, and the air flow may be accelerated by the dimples 401. The dimple 401 may generate a vortex in the discharged air to reduce air resistance and accelerate the air flow. The accelerated air is prone to separate from the surface of the blowing fan 300 or the guide vane 200, but the blade protrusion 311 and the support protrusion 321 prevent separation, and thus the accelerated air may evenly flow along the blade 310 and a downstream side thereof. Accordingly, even if an RPM (fan rotational speed) is high, the air may be caused to flow more efficiently along the surface of the blowing fan 300 or the guide vane 200.

The examples of the present disclosure have been described above as specific embodiments, but these are only examples, and the present disclosure is not limited thereto, and should be construed as having the widest scope according to the technical spirit disclosed in the present specification. A person skilled in the art may combine/substitute the disclosed embodiments to implement a pattern of a shape that is not disclosed, but it also does not depart from the scope of the present disclosure. In addition, those skilled in the art can easily change or modify the disclosed embodiments based on the present specification, and it is clear that such changes or modifications also belong to the scope of the present disclosure.

1. An air treatment device comprising:
a body having an inlet through which air is introduced and an outlet through which the air is discharged to an outside;
a guide vane guiding the filtered air to be discharged in one direction, and having a plurality of protrusions formed on an upper portion thereof;
a blowing fan accommodated inside the body, and configured to rotate about a predetermined center of rotation to provide a blowing force for introducing the air into the interior of the body and discharging the air to the outside;
a duct having a discharge flow path formed therein; and
a filter filtering the air introduced into the interior of the body,
wherein the plurality of protrusions are disposed at an upper side of the blowing fan to convert a flow of the air rising from one surface of the guide vane and the air rising from the other surface of the guide vane into a laminar flow.

2. The air treatment device of claim 1, wherein the blowing fan comprises:
a plurality of blades having at least a portion extending in a direction parallel to the predetermined center of rotation;
a motor providing a driving force for rotating the plurality of blades; and
a blade support connected to the plurality of blades, and extending in a direction offset from the predetermined center of rotation between the motor and the plurality of blades,
wherein a support protrusion configured to generate a vortex is formed on the blade support.

3. The air treatment device of claim 2, wherein the support protrusion is disposed between the plurality of blades on a support surface of the blade support,
a curvature of one surface of the support protrusion is greater than a curvature of the other surface opposite to the one surface of the support protrusion, and
a vertical height of the support protrusion and a width of the support protrusion on the support surface are smaller than a horizontal thickness of each of the plurality of blades.

4. The air treatment device of claim 3, wherein the vertical height and the width of the support protrusion are 0.01 times or more and 0.3 times or less a height and a horizontal width of each of the plurality of blades.

5. The air treatment device of claim 4, wherein a plurality of dimples having a groove shape are formed in the duct, and
the plurality of dimples generate a vortex in the discharged air to reduce air resistance and accelerate air flow.

6. The air treatment device of claim 5, wherein a diameter of one of the plurality of dimples disposed at a lower side is larger than a diameter of another of the plurality of dimples disposed at an upper side.

7. The air treatment device of claim 6, wherein the discharged air flows along an inclined portion of the duct and is accelerated by the plurality of dimples, while being uniformly distributed along an upper surface of each of the plurality of blades without being separated due to the support protrusion.

8. The air treatment device of claim 2, wherein a blade protrusion forming a vortex is formed on each of the plurality of blades.
